(19) United States
(12) Patent Application Publication
(10) Pub. No.: US 2010/0131893 A1
(43) Pub. Date: May 27, 2010

(54) REPLACEABLE GRAPHICAL USER INTERFACE FOR MOBILE COMMUNICATION DEVICE

(75) Inventors: Alard Weisscher, Meerssen (NL); Laurent Eschenauer, Ougee (BE)

Correspondence Address: International IP Law Group, P.O. BOX 691927, HOUSTON, TX, 77269-1927, US

(73) Assignee: Vodafone Holding GmbH, Dusseldorf (DE)

(21) Appl. No.: 12/622,495

(22) Filed: Nov. 20, 2009

(30) Foreign Application Priority Data
Nov. 21, 2008 (EP) 08020293.0

(51) Int. Cl. G06F 3/048

(52) U.S. Cl. 715/810

(57) ABSTRACT

There is provided a mobile communication device. An exemplary mobile communication device comprises an operating system for the mobile communication device and a radio interface for connecting to a wireless network. The exemplary mobile communication device also comprises a display on which a graphical user interface is displayed to enable the user to operate the mobile communication device according to the operating system. The exemplary mobile communication device additionally comprises a local storage where the data files associated with the graphical user interface are stored wherein the local storage permits the storage of a plurality of user interfaces and a manager that manages the graphical user interface such that the user can select one out of the plurality of stored graphical user interfaces.

### CROSS REFERENCE TO RELATED APPLICATION

This application claims priority to European (EP) Patent Application No. 08 020 293.0, filed on Nov. 21, 2008, the contents of which are incorporated by reference as if set forth in their entirety herein.

### BACKGROUND

When today a mobile telephone is released on the market, its graphical user interface i.e. the software part of the telephone user interface is a fixed component usually designed by a manufacturer and/or the network provider and programmed in the manufacturing environment of the mobile telephone. Every mobile telephone user interface is inevitably a compromise given the fact it needs to serve a huge audience with very different needs. This means menus are filled with applications which some users never use, the whole display is showing inappropriate elements and for specific information the user needs to open a browser to find this information. Dependant on how many submenus the user has to open this may be a very inefficient process in some cases.

Such menus may differ greatly in terms of their structure, the number of parameters displayed and the difficulty of using them. The different desires, demands and capabilities of the users mean that there is generally not a single menu which meets the demands of all potential users. In practice, by way of example, a particular menu may be far too complicated and incomprehensible for a first, technically inexperienced user, yet may still be too simple for a second, technically experienced user, because the latter desires further refined setting options or would like to use further services offered.

Even for a single person the most frequently used functionalities may vary throughout a day and a week depending on the context of the daily life of the user. At work, usually calling numbers or caller lists as well as business e-mail functionalities are most important. At home, the same user may never access his business e-mail but rather use a camera and a photo gallery to show photos to visitors. At leisure times, for example on a festival the most important things to this user are latest updates about the festival and notifications when a favorite band starts playing. During holidays, a personal blog may be the most frequently accessed service.

The graphical user interface of today's mobile telephones can only be adapted to a very little extent to fit to the personal context of the user, let alone to a varying context. At most the user has the possibility in some cases to make some accommodations. For example, he may configure some aspects of the graphical user interface such as the language and the date format. He may also change the look and feel of the graphical user interface by selecting a template or by “skinning” the mobile telephone, i.e., changing the appearance of elements shown on the display. In some cases, the user may also install additional applications on the telephone.

From US 2005/0289227 A1 a method for editing a new interface of a portable device by using a browser is known. According to the known method, a new interface of the portable device is edited with texts and graphics provided on a website associated with a server. The user of the portable device connects to the internet and logs in to a website associated with a server. On the server, he may edit text or graph a window or a picture frame of a new user interface. After the editing is finished, the user downloads the information associated with the new user interface into a specific folder of the portable electronic device to replace the original graphical user interface of the device. In this way a personal style of the user interface can be created.

Taking this as a starting point, there still remains a desire to provide a user the possibility to even further adapt the graphical user interface of a mobile communication device according to his needs and preferences.

### SUMMARY OF THE INVENTION

Exemplary embodiments of the present invention relate to a mobile communication device with replaceable or changeable graphical user interfaces. Exemplary embodiments of the present invention may also relate to a server and a system for replacing the graphical user interface of a mobile communication device.

An exemplary mobile communication device may comprise a changeable user interface. In particular, an exemplary mobile communication device may comprise an operating system, a radio interface for connecting to a wireless network, a display on which a graphical user interface is displayed to enable the user to operate the mobile communication device according to the operating system and a local storage where the data files associated with the graphical user interface are stored. In an exemplary embodiment, the local storage permits the storage of a plurality of graphical user interfaces and means for managing the graphical user interface such that the user can select one out of the plurality of stored graphical user interfaces.

According to an exemplary embodiment of the invention, the operating system of the mobile telephone interacts with the graphical user interface such that the user controls the mobile telephone through the selected graphical user interface.

In an exemplary embodiment of the invention, each one of the graphical user interface may offer a menu to select another one of the plurality of graphical user interface.

An exemplary embodiment of the present invention provides a graphics component for rendering the graphical user interface. The graphics component can associate functionalities and/or services with elements of the graphical user interface. Moreover, the graphics component may provide a considerable flexibility for the user to adapt the graphical user interface.

In another exemplary embodiment, a dynamic graphics component that renders the graphical user interface can perform an automatic rendering of the graphical user interface. The dynamic graphics component can perform an automatic rendering of the graphical user interface as a function of day time.

The dynamic graphics component for rendering the graphical user interface may perform an automatic rendering of the graphical user interface as a function of the calendar day. In this case, the dynamic graphics component can be arranged to monitor and store the user behavior. It may be convenient if the automatic rendering of the graphical user interface is based on the monitored user behavior. The dynamic graphics component may support the user in adapting the graphical user interface. It helps him to find the most efficient graphical user interface for his needs.

In yet another exemplary embodiment of the present invention, the mobile communication device may be provided with a manager that enables a user to download a graphical user interface from a remote device. The manager can control the storage of the downloaded graphical user interface in the local storage. In cases where the graphical user interfaces stored in the local storage do not meet the needs of a specific user, the manager may allow installing another graphical user interface from a remote device.

An exemplary embodiment of the present invention may relate to a server that provides a website on which a selection of graphical user interfaces are displayed, wherein a user can select a specific graphical user interface for download out of a plurality of graphical user interfaces, wherein the server comprises a download manager which executes the download of the data files associated with a selected graphical user interface to a receiving device. The server may be a remote device from which graphical user interfaces can be downloaded if the graphical user interfaces stored on the mobile communication device cannot satisfy the needs of a specific user. The website of the server can be provided with a gallery of graphical user interfaces from which a specific graphical user interface is selectable by a user. Since the storage capacity of the server is much larger than the local storage of the mobile communication device, it is possible to offer the user a very large variety of graphical user interfaces for download.

Finally, an exemplary embodiment of the present invention relates to a system comprising a mobile communication device and a server.

### BRIEF DESCRIPTION OF THE DRAWINGS

Certain exemplary embodiments are described in the following detailed description and in reference to the drawings, in which:

FIG. 1 is a front view of a mobile telephone, according to an exemplary embodiment of the present invention;

FIG. 2 is a diagram showing a detailed view of the display of the mobile telephone of FIG. 1, according to an exemplary embodiment of the present invention; and

FIG. 3 is a block diagram showing an architecture of a system, according to an exemplary embodiment of the present invention.

In the drawings, identical or similar elements are labeled with the same reference numbers.

### DETAILED DESCRIPTION OF SPECIFIC EMBODIMENTS

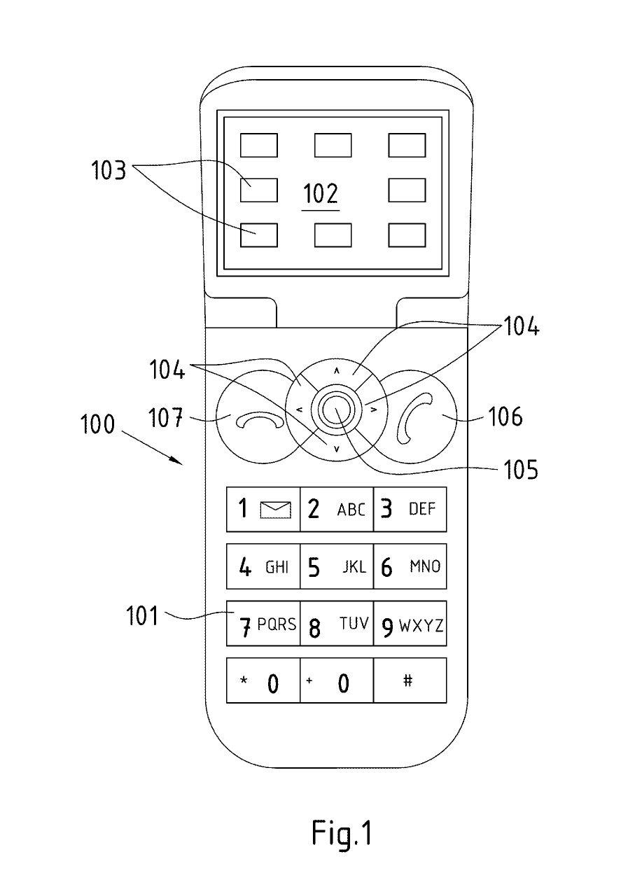

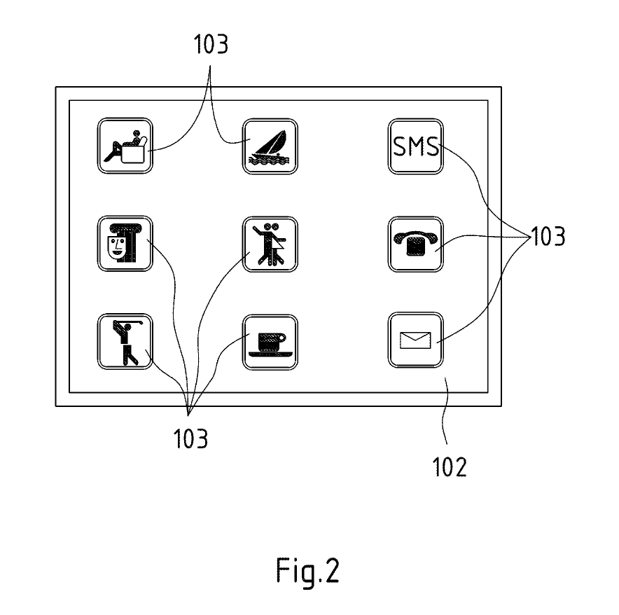

FIG. 1 shows a front view of a mobile telephone according an exemplary embodiment of the present invention. The mobile telephone is labeled as a whole with the reference number 100. In the lower part of the front side of the mobile telephone 100, there is a key pad 101 enabling a user to input telephone numbers and text. In the upper portion of the front side of the mobile telephone 100, there is a display 102 for displaying dialed telephone numbers as well as telephone numbers of callers. The display 102 is also utilized to display the text of SMS messages and the visual contents of MMS messages. The display 102 is also used to display icons 103 enabling the user to access in a quick and convenient way certain functionalities of the mobile telephone such as SMS messaging, MMS messaging, e-mails and address books to name only a few examples. This aspect will be described with reference to FIG. 2 showing the display 102 in greater detail. In order to select a certain functionality the user moves a cursor (not shown in FIG. 1) onto an icon 103 displayed on the screen 102 by cursor buttons 104 and pushes a select button 105 to execute the selection. The mobile telephone 100 further includes a button 106 to initiate a telephone call and a button 107 to terminate the telephone call.

The mobile telephone 100 is only a representative example of numerous different types of mobile communication devices such as personal data assistants (PDA) that may incorporate an exemplary embodiment of the present invention. For the sake of simplicity, however, we refer only to a mobile telephone but other mobile communication devices may take the place of the mobile telephone in connection with exemplary embodiments of the present invention. Moreover, exemplary embodiments of the present invention is not limited to mobile telephones and may include any other types of mobile communication devices having a graphical user interface.

The exemplary mobile telephone 100 may be wirelessly connected to a PLMN (Public Land Mobile Network) via a radio access network. The PLMN is the core network of the mobile communication system operated by a mobile network operator and may be configured according to the GSM standard or according to the UMTS standard, for example. The radio access network may be configured as a GERAN (GSM Edge Radio Access Network) according to the GSM specification or as an UTRAN (Universal Terrestrial Radio Access Network) according to the UMTS specification, for example. The UMTS specification permits the user to connect wirelessly to the internet at a comparable data rate as with DSL connections.

In FIG. 2, the display 102 of the mobile telephone 100 shown in FIG. 1 is shown in greater detail. In FIG. 2, the different kinds of icons 103 and the functionality which is associated with each of these icons 103 is visible. In the example shown in FIG. 2, the functionalities are telephone calls, email editing and sending, SMS messaging, appointments with friends, sport events, cultural events and other items which are important for the user of the mobile telephone 100. The described functionalities are only meant as illustrative examples and shall not be construed to limit the scope of exemplary embodiments of the present invention.

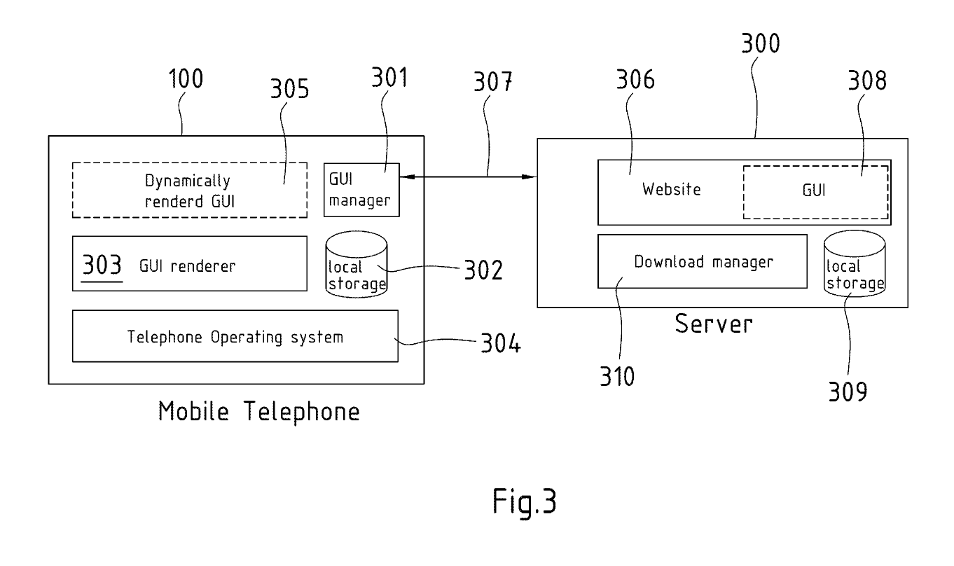

FIG. 3 shows a high-level architecture of a system in accordance with an exemplary embodiment of the present invention. The system comprises the mobile telephone 100 and a server 300. The mobile telephone 100 includes a graphical user interface manager 301 (graphical user interface manager) and a local storage 302. In the local storage 302, a plurality of different kinds of graphical user interfaces are stored. The size of the local storage 302 is dimensioned to allow storing a plurality of graphical user interfaces to make them easily and quickly accessible by simply selecting one of them through a menu. The graphical user interface manager 301 enables the user to select one of the graphical user interfaces which are available on the local storage 302 such that the operating system of the mobile telephone 100 presents the selected graphical user interface to the user. The graphical user interface manager offers the user the possibility to replace the graphical user interface which is installed on his mobile phone with another one displaying different data and having a different flow of menus i.e. the user may change the sequence of screens and how to navigate from one screen to another one. This is a considerable advantage over the prior art because designing and building a mobile telephone user interface is at present very difficult and complex such that it is reserved to specialized designers and engineers.

In an exemplary embodiment of the present invention, each of the graphical user interfaces stored in the local storage displays a menu enabling a user to manually switch to another graphical user interface.

In another exemplary embodiment of the present invention, the user can manually switch to another user interface using a hardware switch or button provided on the mobile telephone.

The local storage 302 may comprise a memory device inside the telephone, a memory included in the subscriber identity module of the mobile telephone or an additional memory card that can be inserted into the mobile telephone. In spite of the new flexibility that an exemplary embodiment of the present invention offers, there may still be a situation that the plurality of graphical user interface stored in the local storage 302 still does not meet all needs of a specific user. Therefore, the graphical user interface manager 301 may also enable the user to browse a remote storage for new graphical user interfaces to download and install on the mobile telephone 100.

The exemplary mobile telephone 100 includes a graphical user interface renderer for rendering the selected graphical user interface. The graphical user interface renderer 303 links data to display with native or remote data sources and links the user interactions with native or remote action such as a telephone call, send SMS messages, post message to a blog, etc. The graphical user interface renderer 303 associates functionalities of the mobile telephone 100 or of remote services with icons 103 represented on the display 102. In this way, the graphical user interface renderer 303 creates a large versatility of the mobile telephone 100.

The mobile telephone 100 includes a telephone operating system 304 which is controlled by the user through the graphical user interface currently selected by the graphical user interface manager 301. The telephone operating system 304 comprises all hard- and software to enable native telephone functionalities, e.g., setting up and receiving telephone calls and email, SMS (short message service) and MMS (multimedia message service) communication to name only a few.

A mobile telephone 100 according to an exemplary embodiment of the present invention may be provided with a dynamic graphical user interface renderer 305.

In an exemplary embodiment of the invention, the dynamic graphical user interface renderer 305 provides for an automatic change of the graphical user interface as function of the day time, day of the week and whether the user is on vacation besides the manual selection of the user. During the day time of normal working days, the mobile telephone presents a “business” graphical user interface putting functionalities to the foreground which are predominantly used during the working time of the user. After the normal working hours the mobile telephone switches to a “leisure” graphical user interface in which other functionalities are in the foreground which are mainly used by the user in his leisure time. Similar changes occur between normal working days on the one hand and weekends and vacation on the other hand. The changes are controlled by the mobile phone 100 and do not require any user interaction to occur.

In another exemplary embodiment, the graphical user interface is replaced upon a user input and at the same time, the graphical user interface is changed automatically as a function of daytime and calendar day.

In yet another exemplary embodiment of the invention, the dynamic graphical user interface renderer 305 monitors the user behavior over a relatively long period of time and stores it. The ascertained result relating to the user behavior is used to offer to the user as preferences in the displayed menu such menu items the user has predominately chosen in the past according to the user behavior ascertained. The dynamic graphical user interface renderer 305 shows upon request an adapted menu and waits for the confirmation of the adapted menu by the user. If the user does so, the graphical user interface renderer stores the adapted menu in the local storage 302.

In order to access an even enhanced choice of graphical user interfaces, the user can connect to a website 306 on the remote server 300. A data communication link 307 between the mobile telephone 100 and the server 300 may be established wirelessly via conventional data communication services offered by service providers. The website 306 enables the user to remotely configure the graphical user interface of his mobile telephone by browsing a gallery 308. The data files associated with each one of the graphical user interfaces presented in the graphical user interface gallery 308 are stored in the local storage 309 of the server 300. Upon the selection of a specific graphical user interface, the graphical user interface manager 301 of the mobile telephone 100 interfaces with a download manager 310. The download manager 310 may comprise an application running on the server. In an exemplary embodiment, the download manager 310 accesses the data file associated with the selected graphical user interface and transfers it via the data communication link 307 to the graphical user interface manager 301. As soon as the data file associated with the selected graphical user interface has been downloaded completely, it is stored in the local storage 302 of the mobile telephone 100. The server 300 and the mobile telephone 100 cooperate to form a system enabling a user to replace the graphical user interface of the mobile telephone 100.

Exemplary embodiments of the invention permit different types of graphical user interfaces at hand, e.g., a simplified graphical user interface when the mobile telephone is loaned to a child or to another person who is not skilled in operating modern communication devices.

While exemplary embodiments of the present invention have been illustrated and described in detail in the drawings and foregoing description, such illustration and description are to be considered illustrative or exemplary and not restrictive; the invention is not limited to the disclosed embodiments. Particularly, the invention is not limited to a download of an application or program code to the local storage 302. A person skilled in the art recognises that other data can be downloaded to the local storage 302 in the same way as it has been described before in connection with the download of a program code of an application. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### LIST OF REFERENCE NUMERALS

100 mobile telephone
101 key pad
102 display
103 icon
104 cursor buttons
105 select button
106, 107 buttons
300 server
301 graphical user interface manager
302 local storage
303 graphical user interface renderer
304 telephone operating system
305 dynamic graphical user interface renderer
306 web site
307 data communication link
308 graphical user interface gallery
309 local storage
310 download manager

What is claimed is:

1. A mobile communication device, comprising:
an operating system for the mobile communication device;
a radio interface for connecting to a wireless network;
a display on which a graphical user interface is displayed to enable the user to operate the mobile communication device according to the operating system;
a local storage where the data files associated with the graphical user interface are stored wherein the local storage permits the storage of a plurality of user interfaces; and
a manager that manages the graphical user interface such that the user can select one out of the plurality of stored graphical user interfaces.

2. The mobile communication device recited in claim 1, wherein the operating system of the mobile communication device interacts with the graphical user interface such that the user controls the mobile communication device through the selected graphical user interface.

3. The mobile communication device recited in claim 1, wherein each one of the graphical user interfaces offers a menu to select another one of the plurality of graphical user interfaces.

4. The mobile communication device recited in claim 1, comprising a graphics component that is adapted to render the graphical user interface.

5. The mobile communication device recited in claim 4, wherein the graphics component is adapted to associate functionalities and/or services with elements of the graphical user interface.

6. The mobile communication device recited in claim 4, wherein the graphics component comprises a dynamic component that is adapted to automatically render the graphical user interface.

7. The mobile communication device recited in claim 6, wherein the dynamic component is adapted to perform an automatic rendering of the graphical user interface as a function of day time.

8. The mobile communication device recited in claim 6, wherein the dynamic component is adapted to perform an automatic rendering of the graphical user interface as a function of the calendar day.

9. The mobile communication device recited in claim 6, wherein the dynamic component is adapted to monitor and store the user behavior.

10. The mobile communication device recited in claim 9, wherein the dynamic component is adapted to automatically render the graphical user interface based on the monitored user behavior.

11. The mobile communication device recited in claim 1, wherein the manager is adapted to enable a user to download a graphical user interface from a remote device.

12. The mobile communication device recited in claim 11, wherein the manager is adapted to control the storage of the downloaded graphical user interface in the local storage.

13. A server that is adapted to provide a website on which a selection of graphical user interfaces are displayed, wherein a user can select a specific graphical user interface for download out of a plurality of graphical user interfaces, the server comprising a download manager that executes a download of data files associated with a selected graphical user interface to a receiving device.

14. The server recited in claim 13, wherein the website provides a gallery of graphical user interfaces from which a specific graphical user interface is selectable by a user.

15. A communication system, comprising:
a mobile communication device, comprising:
an operating system for the mobile communication device;
a radio interface for connecting to a wireless network;
a display on which a graphical user interface is displayed to enable the user to operate the mobile communication device according to the operating system;
a local storage where the data files associated with the graphical user interface are stored wherein the local storage permits the storage of a plurality of user interfaces; and
a manager that manages the graphical user interface such that the user can select one out of the plurality of stored graphical user interfaces; and
a server that is adapted to provide a website on which a selection of graphical user interfaces are displayed, wherein a user can select a specific graphical user interface for download out of the selection of graphical user interfaces, the server comprising a download manager that executes a download of data files associated with a selected graphical user interface to the mobile communication device.
